(19) United States
(12) Patent Application Publication
(10) Pub. No.: US 2023/0103700 A1
(43) Pub. Date: Apr. 6, 2023

(54) HINGE STRUCTURE FOR IN-FOLDING TYPE DISPLAY DEVICE

(71) Applicant: AUFLEX CO., LTD., Hwaseong-si (KR)

(72) Inventors: Hyun Min PARK, Suwon-si (KR); Seoung Jun LEE, Uiwang-si (KR)

(21) Appl. No.: 17/911,515

(22) PCT Filed: Mar. 17, 2021
(86) PCT No.: PCT/KR2021/003317

§ 371 Date: Sep. 14, 2022

(30) Foreign Application Priority Data
Mar. 17, 2020 (KR) 10-2020-0032905
Mar. 18, 2020 (KR) 10-2020-0033504

(51) Int. Cl. G06F 1/16

(52) U.S. Cl. CPC G06F 1/1681; G06F 1/1616; G06F 1/1656

(57) ABSTRACT

A hinge structure for an in-folding type display device is provided which allows a smartphone to be automatically folded or unfolded with an elastic force of a spring and in which the spring is disposed inside of foldable connecting plates instead of being disposed at positions of a fixing cam and a moving cam provided in a foldable hinge according to the related art, whereby a large space for disposing the spring can be secured to use a spring with a large diameter.

### TECHNICAL FIELD

The invention relates to a hinge structure for a display device and, more particularly, to a hinge structure for an in-folding type display device which allows a smartphone to be automatically folded or unfolded with an elastic force of a spring and in which the spring is disposed inside of foldable connecting plates instead of being disposed at positions of a fixing cam and a moving cam provided in a foldable hinge according to the related art, whereby a large space for disposing the spring can be secured to use a spring with a large diameter.

### BACKGROUND ART

Mobile communication terminals are configured to perform various functions. Examples of the functions include a data and speech communication function, a function of capturing a still image or a moving image using a camera, a speech storing function, a function of reproducing a music file using a speaker system, and a function of displaying a still image or a moving image (a video).

Some mobile communication terminals have additional functions for playing games, and some mobile communication terminals are embodied as multimedia devices. Recent mobile communication terminals can also receive broadcast or multicast signals and reproduce a video or a television program.

Researches for supporting and improving other functions of mobile communication terminals in addition to the above-mentioned functions have been carried out. These researches include modification and improvement of structural constituents of the mobile communication terminals and addition and improvement of software or hardware.

In general, a display module of a mobile communication terminal displays information which is processed by the mobile communication terminal. For example, when the mobile communication terminal is in a call mode, the display module displays a user interface (UI) or a graphic user interface (GUI) associated with a call.

When the mobile communication terminal is in a video call mode or an image capturing mode, the display module displays a captured or/and received image, a UI, or a GUI. The display module includes a liquid crystal display (LCD), a thin-film transistor liquid crystal display, an organic light emitting diode (OLED), a flexible display, or a 3D display.

A flexible display (or a flexible LCD) has been regularly researched with its merit of deformability. It takes much time to use a rolled display like a paper roll as shown in science-fiction movies.

Therefore, transitional forms of flexible displays will be many used until the flexible displays are regularly used with sufficient development thereof, and these transitional forms will be similar to current structures of communication terminals. Accordingly, there is necessity for description of usage and protection of flexible displays when such flexible displays are used in mobile communication terminals.

An example of such a hinge structure for a mobile communication terminal having a flexible display panel installed therein is disclosed in Korean Patent Application Laid-open No. 10-2015-0096827 (Title of the Invention: HINGE STRUCTURE AND FOLDABLE DISPLAY DEVICE INCLUDING THE SAME).

### SUMMARY OF INVENTION

### Technical Problem

An objective of the invention is to provide a hinge structure for an in-folding type display device which allows a smartphone to be automatically folded or unfolded with an elastic force of a spring and in which the spring is disposed inside of foldable connecting plates instead of being disposed at positions of a fixing cam and a moving cam provided in a foldable hinge according to the related art, whereby a large space for disposing the spring can be secured to use a spring with a large diameter.

### Solution to Problem

In order to achieve the above-mentioned objectives, there is provided a hinge structure for an in-folding type display device, the hinge structure including: a pair of connecting plates that rotates in opposite directions; an elasticity unit that provides an elastic force to rotation of the connecting plates; a plate connecting portion that connects the pair of connecting plates; and an elastic connecting portion that connects the connecting plates and the elasticity unit by causing the elasticity unit to generate an elastic force when the pair of connecting plates rotate.

An elasticity control portion that includes a first recessed portion, a protruding portion, and a second recessed portion to correspond to an angle by which the connecting plates are folded may be provided in the elastic connecting portion.

The elasticity unit may not generate an elastic force when the elastic connecting portion is located in the first and second recessed portions.

The elasticity unit may generate an elastic force when the elastic connecting portion is located in the protruding portion.

A rotation link that supports rotation of the connecting plates may be provided in the plate connecting portion.

The rotation link may rotate along a rail, and the rail may rotate about a portion connected to the connecting plates.

The connecting plates may be unfolded straightly when the elastic connecting portion is located in the first recessed portion.

The connecting plates may be folded straightly when the elastic connecting portion is located in the second recessed portion.

### Advantageous Effects of Invention

With the hinge structure for an in-folding type display device according to the invention, it is possible to install a spring with a large diameter and thus to fold and unfold a foldable smartphone with a sufficient elastic force.

In a folding hinge according to the related art using a rotating cam and a moving cam, a spring for applying an elastic force is disposed behind the moving cam that moves straightly with rotation of the rotating cam.

The diameter of the spring disposed behind the moving cam in the related art is limited by a diameter, a height, a width, or the like of the rotating cam or the moving cam. Accordingly, it is difficult to use a spring with a large diameter and thus the spring which is an elastic member does not provide a large elastic force.

When a foldable smartphone is performing a folding or unfolding operation, a battery and the like are mounted in two foldable panels and thus a weight thereof is considerably large. Accordingly, it is necessary to use a spring with a large elastic force in order to smoothly fold or unfold of the panels of the smartphone.

According to the invention, since a spring is not disposed behind a moving cam but can be disposed in each of a pair of connecting plates, it is possible to secure a larger space for disposing the spring and thus to use a spring with a larger diameter. Accordingly, it is possible to more smoothly perform a folding or unfolding operation of a smartphone using a spring with a larger elastic force.

### BRIEF DESCRIPTION OF DRAWINGS

FIG. 1 is a perspective view illustrating a state in which a flexible display panel is installed in a display device in which a hinge structure for an in-folding type display device according to the invention is provided.

FIG. 2 is a perspective view illustrating a state in which upper panels are assembled with a hinge in the display device in which the hinge structure for an in-folding type display device according to the invention is provided.

FIG. 3 is a perspective view illustrating a state in which the hinge structure is coupled to one upper panel in the display device in which the hinge structure for an in-folding type display device according to the invention is provided.

FIG. 4 illustrates a perspective view of the hinge structure in which the upper panels are being folded in the display device in which the hinge structure for an in-folding type display device according to the invention is provided.

FIG. 5 illustrates a perspective view of the hinge structure in which the upper panels have been fully folded in the display device in which the hinge structure for an in-folding type display device according to the invention is provided.

FIG. 6 illustrates a perspective view of the hinge structure for an in-folding type display device according to the invention.

FIG. 7 illustrates an exploded perspective view and an assembled perspective view of the hinge structure for an in-folding type display device according to the invention.

FIG. 8 illustrates an exploded perspective view and an assembled perspective view of an internal structure of connecting plates in the hinge structure for an in-folding type display device according to the invention.

FIG. 9 illustrates a partially exploded perspective view of Parts A, B, and C of the hinge structure for an in-folding type display device according to the invention.

FIG. 10 is an exploded perspective view of Part A in FIG. 9.

FIG. 11 is an exploded perspective view of Part B in FIG. 9.

FIG. 12 is an exploded perspective view of Part C in FIG. 9.

FIG. 13 is a perspective view of a state in which a first end of a rotation rod is installed in an elasticity control portion according to the invention.

FIG. 14 is a perspective view illustrating a configuration of the elasticity control portion according to the invention in FIG. 13.

FIG. 15 is a perspective view illustrating a configuration of the elasticity control portion according to the invention in FIG. 14 in a state in which a rotation link, a connection gear, and an arm gear have been assembled into a rotation unit body.

FIG. 16 is a plan view illustrating a state in which the connecting plates has been unfolded in the hinge structure for an in-folding type display device according to the invention.

FIG. 17 is a plan view illustrating an internal structure of a pair of connecting plates in a state in which the connecting plates have been unfolded in the hinge structure for an in-folding type display device according to the invention.

FIG. 18 is a perspective view illustrating an internal structure of a pair of connecting plates in a state in which the connecting plates have been unfolded in the hinge structure for an in-folding type display device according to the invention.

FIG. 19 is a plan view illustrating a state in which the connecting plates are being folded in the hinge structure for an in-folding type display device according to the invention.

FIG. 20 is a plan view illustrating an internal structure of a pair of connecting plates in a state in which the connecting plates are being folded in the hinge structure for an in-folding type display device according to the invention.

FIG. 21 is a perspective view illustrating an internal structure of a pair of connecting plates in a state in which the connecting plates are being folded in the hinge structure for an in-folding type display device according to the invention.

FIG. 22 is a plan view illustrating a state in which the connecting plates have been fully folded in the hinge structure for an in-folding type display device according to the invention.

FIG. 23 is a plan view illustrating an internal structure of a pair of connecting plates in a state in which the connecting plates have been fully folded in the hinge structure for an in-folding type display device according to the invention.

FIG. 24 is a perspective view illustrating an internal structure of a pair of connecting plates in a state in which the connecting plates have been fully folded in the hinge structure for an in-folding type display device according to the invention.

FIG. 25 is a cross-sectional front view illustrating a state in which a second end of a rotation rod is moving on the elasticity control portion with movement of the pair of connecting plates in the hinge structure for an in-folding type display device according to the invention.

FIG. 26 is an exploded perspective view illustrating another example of the rotation unit module illustrated in FIG. 10.

### REFERENCE SIGNS LIST

6: Flexible display panel, 10: Upper panel
30: Connecting plate, 32: Rotation rod
34: Rod, 36: Spring (compressive coil spring)
50: Elasticity control portion, 52: Connection gear, 54: Aim gear
56: Guide groove, 59: Rotation guide, 72: First rotation link
82: First recessed portion, 84: Protruding portion
86: Second recessed portion, 131: First end, 132: Second end

### DESCRIPTION OF EMBODIMENTS

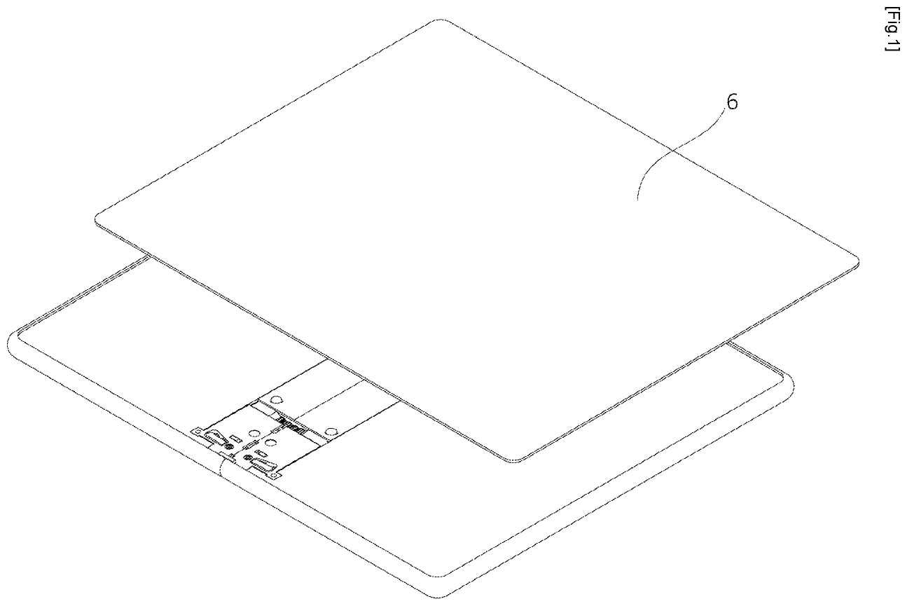

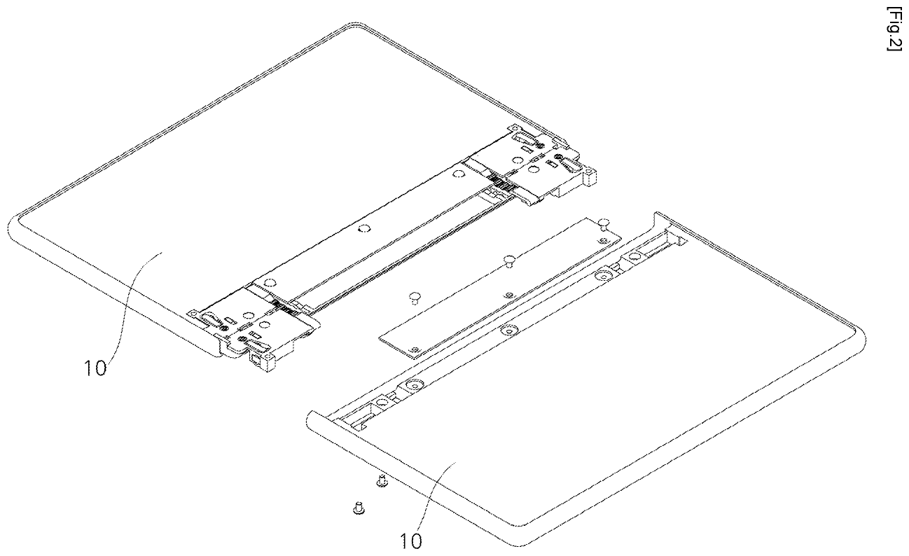

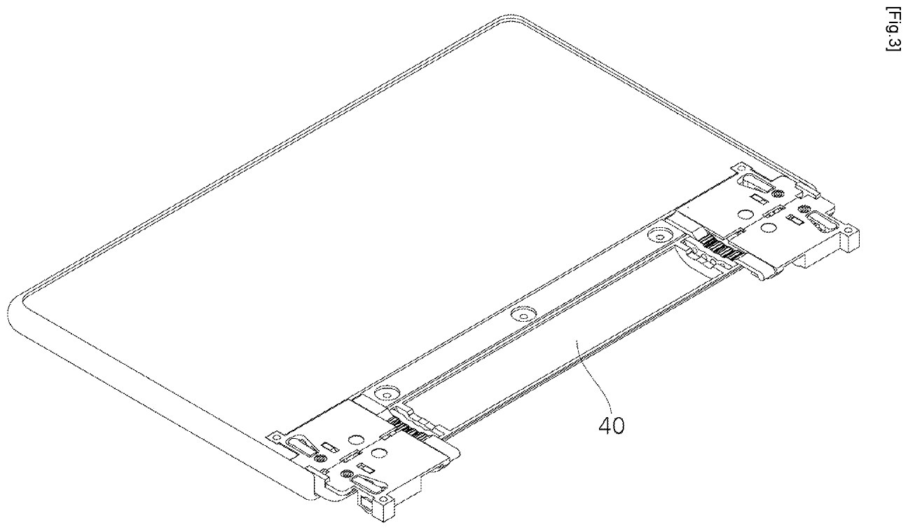

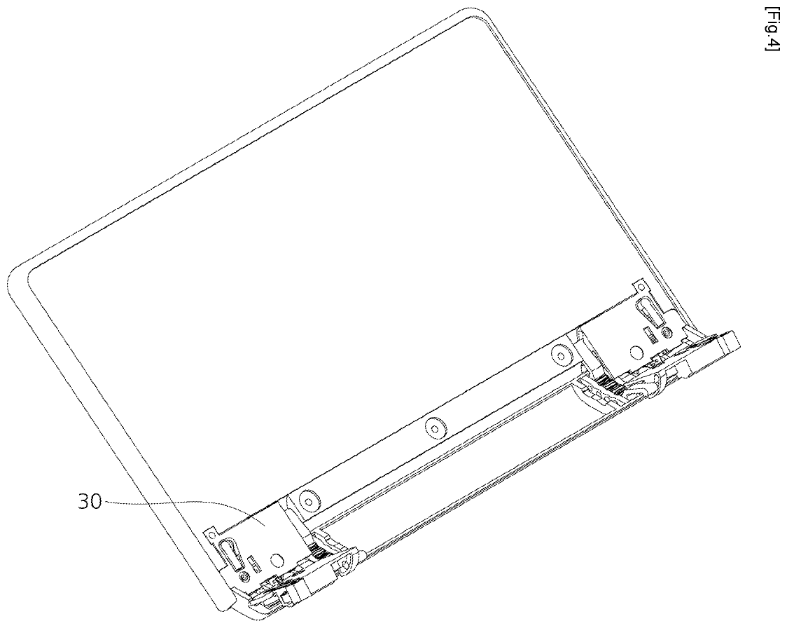

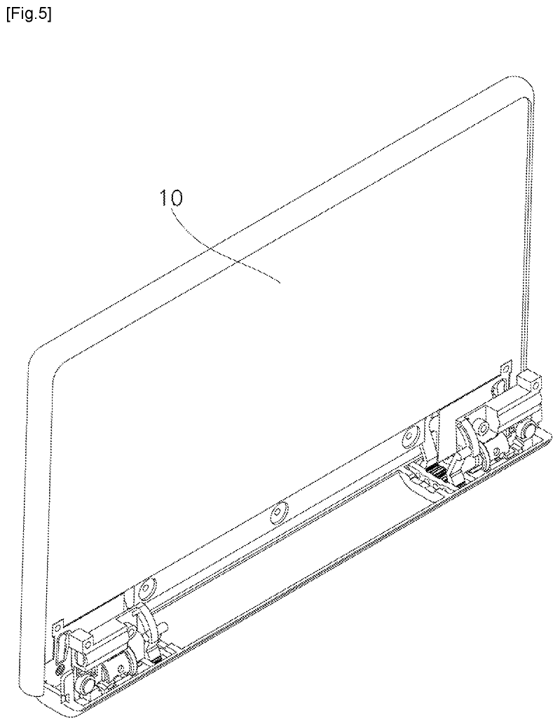

FIG. 1 is a perspective view illustrating a state in which a flexible display panel is installed in a display device in which a hinge structure for an in-folding type display device according to the invention is provided. FIG. 2 is a perspective view illustrating a state in which upper panels are assembled with a hinge in the display device in which the hinge structure for an in-folding type display device according to the invention is provided. FIG. 3 is a perspective view illustrating a state in which the hinge structure is coupled to one upper panel in the display device in which the hinge structure for an in-folding type display device according to the invention is provided. FIG. 4 illustrates a perspective view of the hinge structure in which the upper panels are being folded in the display device in which the hinge structure for an in-folding type display device according to the invention is provided. FIG. 5 illustrates a perspective view of the hinge structure in which the upper panels have been fully folded in the display device in which the hinge structure for an in-folding type display device according to the invention is provided.

Referring to FIGS. 1 to 5, a hinge structure for an in-folding type display device according to the invention is installed in a central portion in which a pair of upper panels 10 is folded.

A flexible display panel 6 is installed on the pair of upper panels 10 connected to be folded with the hinge structure according to the invention.

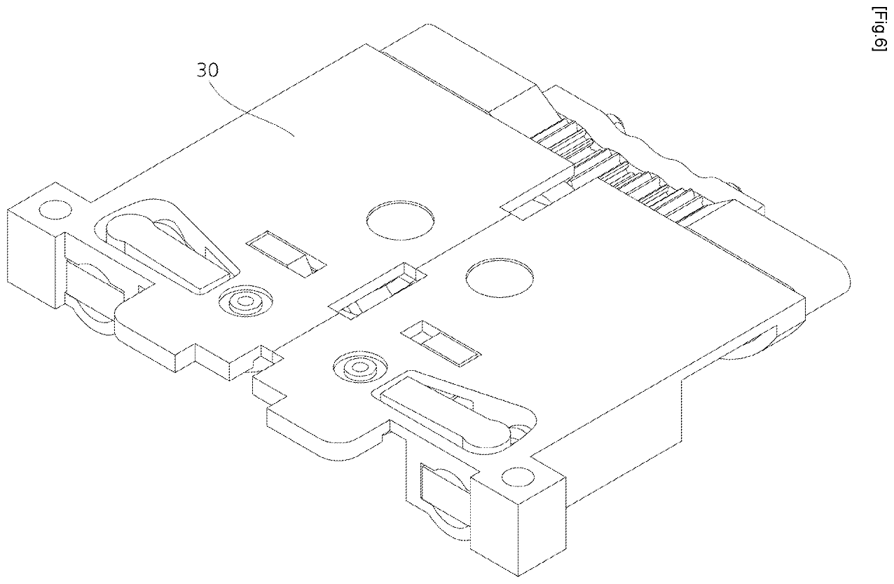

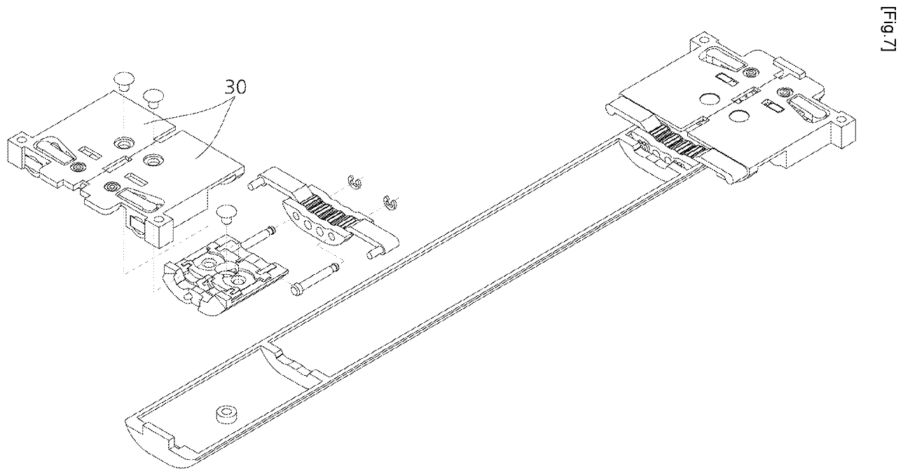

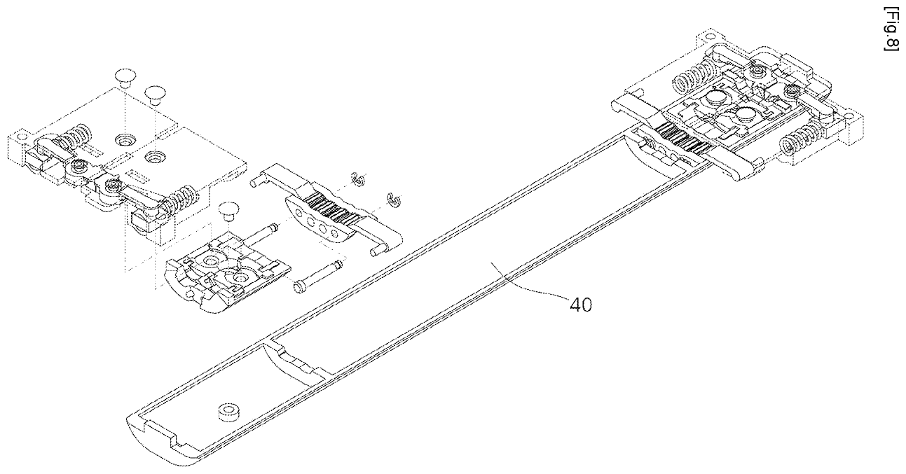

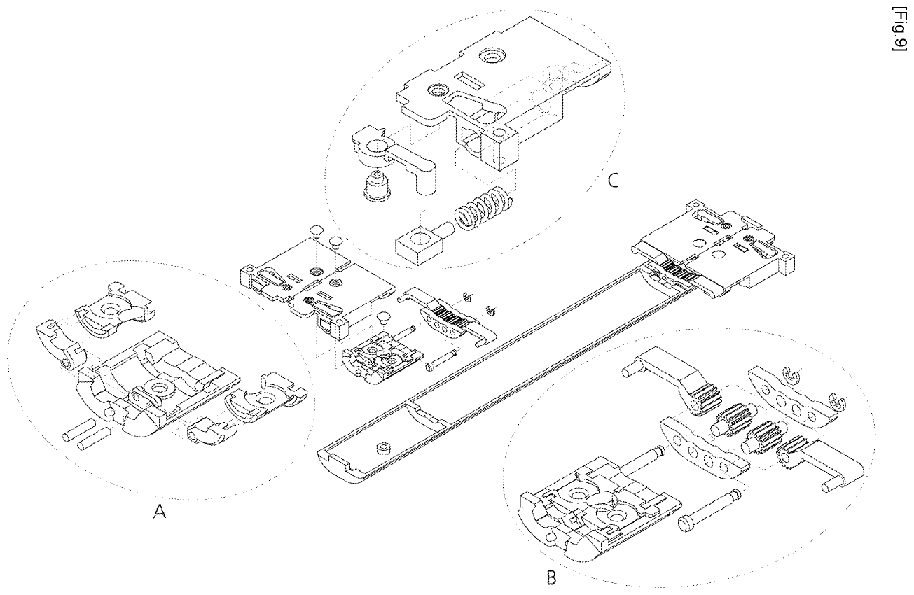

FIG. 6 illustrates a perspective view of the hinge structure for an in-folding type display device according to the invention. FIG. 7 illustrates an exploded perspective view and an assembled perspective view of the hinge structure for an in-folding type display device according to the invention. FIG. 8 illustrates an exploded perspective view and an assembled perspective view of an internal structure of connecting plates in the hinge structure for an in-folding type display device according to the invention. FIG. 9 illustrates a partially exploded perspective view of Parts A, B, and C of the hinge structure for an in-folding type display device according to the invention.

Referring to FIGS. 6 to 9, the hinge structure for an in-folding type display device according to the invention includes a pair of connecting plates 30 that is folded in the opposite directions. The connecting plates 30 are connected to the corresponding upper panels 10 and are configured to rotate with rotation of the upper plates 10.

The hinge structure for an in-folding type display device according to the invention is installed in a central case 40.

The hinge structure for an in-folding type display device according to the invention has a configuration in which three parts including Parts A, B, and C illustrated in FIG. 9 are assembled.

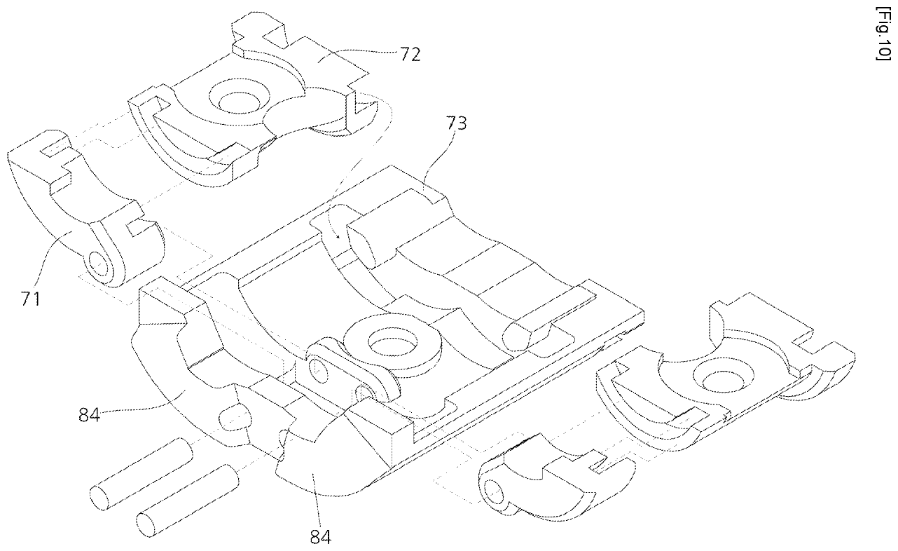

FIG. 10 is an exploded perspective view of Part A in FIG. 9.

Referring to FIG. 10, Part A represents a rotation unit module 70 that causes the pair of connecting plates 30 to rotate in the opposite directions.

The rotation unit module 70 according to the invention includes a pair of first rotation links 72 that is connected to the pair of connecting plates 30 and rotates therewith and a rotation unit body 73 that is connected to an arc-shaped rail 71 such that the first rotation links 72 are inserted thereinto and rotate.

The first rotation link 72 according to the invention is configured to rotate along the rail 71 formed in an arc shape in the rotation unit body 73.

The rail 71 according to the invention is connected to the rotation unit body 73 and is configured to rotate.

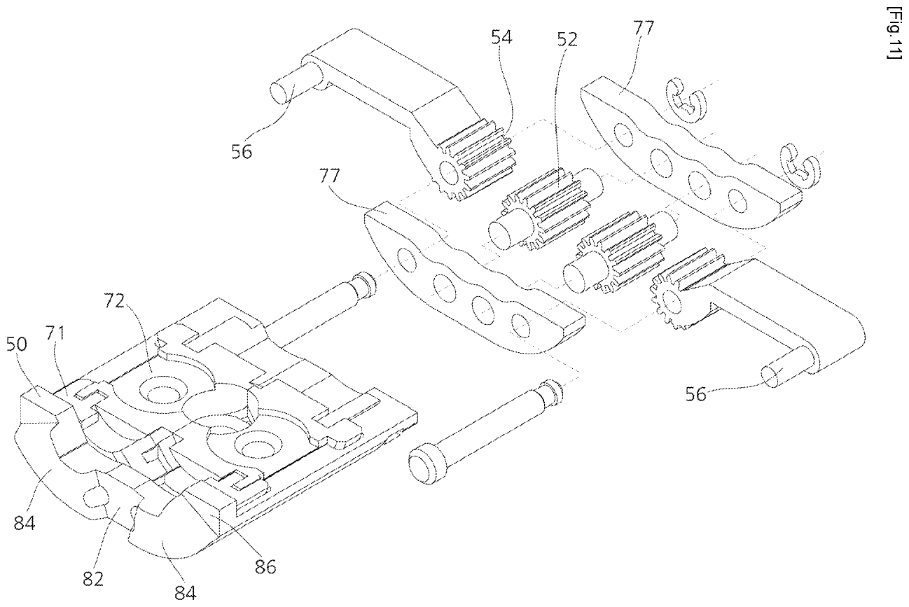

FIG. 11 is an exploded perspective view of Part B in FIG. 9.

Referring to FIG. 11, Part B includes two connection gears 52 that is located at the center in a state in which the pair of connecting plates 30 are attached, the pair of first rotation links 72 rotating with the connecting plates 30 and the rotation unit body 73 having the rail 71 installed therein are disposed, two arm gears 54 that engage with the connection gears 52, and gear connecting portions 77 that support the engagement such that the connection gears 52 and the arm gears 54 rotate.

A guide protruding portion 56 that is inserted into a rotation guide 59 including a curved guide groove formed in the corresponding connecting plate 30 and causes the corresponding aim gear 54 to rotate along the rotation guide 59 is formed in each aim gear 54 according to the invention.

When the first rotation links 75 coupled to the pair of connecting plates 30 rotate in the opposite directions and are folded or unfolded along with the corresponding connecting plates 30, the aim gears 54 also rotate with the movement of the guide protruding portion 56 along the rotation guide 59 and thus the connection gears 52 also rotate.

On the side of the rotation unit body 73 opposite to the side on which the connection gears 72 and the arm gears 54 are provided, an elasticity control portion 50 including protruding portions 84 which are formed to be convex and recessed portions 82 and 86 which are formed to be concave is formed.

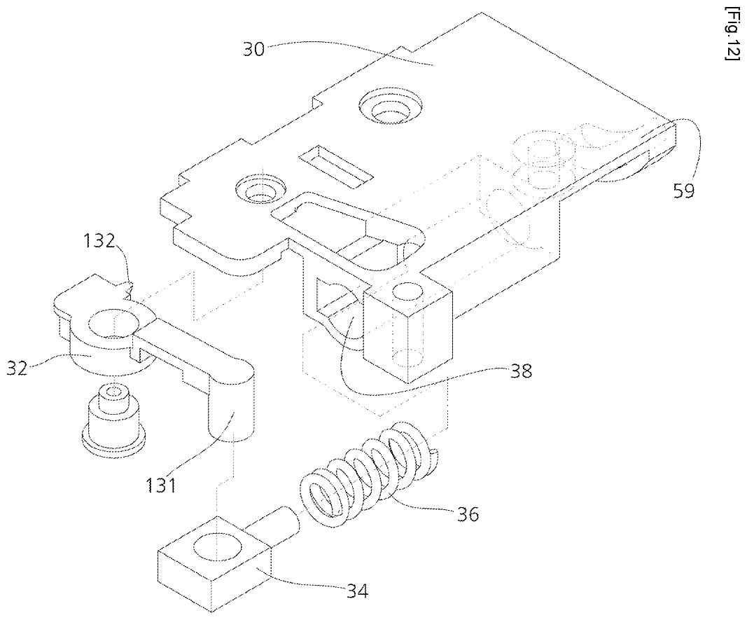

FIG. 12 is an exploded perspective view of Part C in FIG. 9.

Referring to FIG. 12, a rotation rod 32 is connected to each connecting plate 30 and is configured to rotate about a position connected to the corresponding connecting plate 30.

Second ends 132 of a pair of rotation rods 32 are configured to come into contact with the protruding portions 84 and the recessed portions 82 and 86 of the elasticity control portion 50 and to move along the protruding portions 84 and the recessed portions 82 and 86. Rods 34 having a spring 36 installed therein are connected to first ends 131 thereof.

The rod 34 having the spring 36 installed therein is accommodated in an accommodation portion 38 in the corresponding connecting plate 30. The rod 34 is configured to compress the spring 36 accommodated in the accommodation portion 38 when the rotation rod 32 rotates to the side on which the spring 36 is located. That is, an elastic force (a restoration force) is generated while the coil spring 36 is being compressed.

The rotation guide 59 including a curved guide groove is formed in the corresponding connecting plate 30. The guide protruding portion 56 of the corresponding arm gear is inserted into the rotation guide 59 and the aim gear 54 moves along the rotation guide 59.

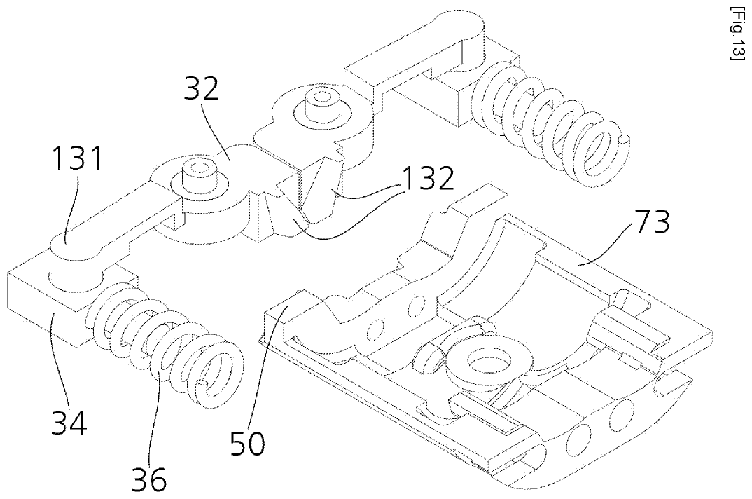

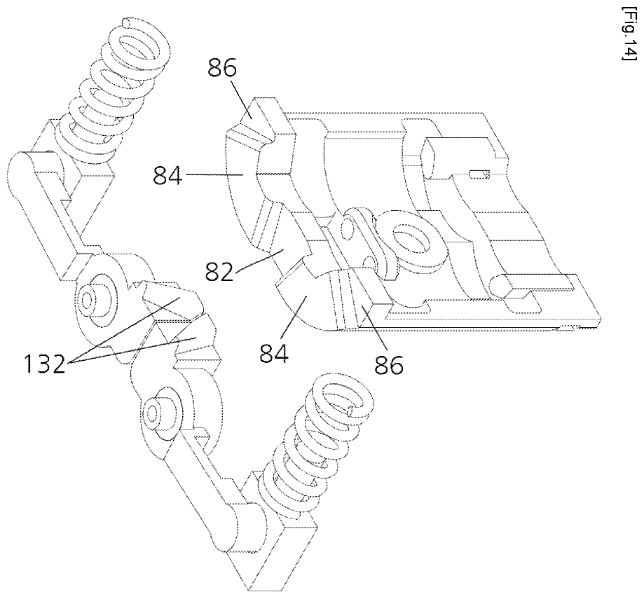

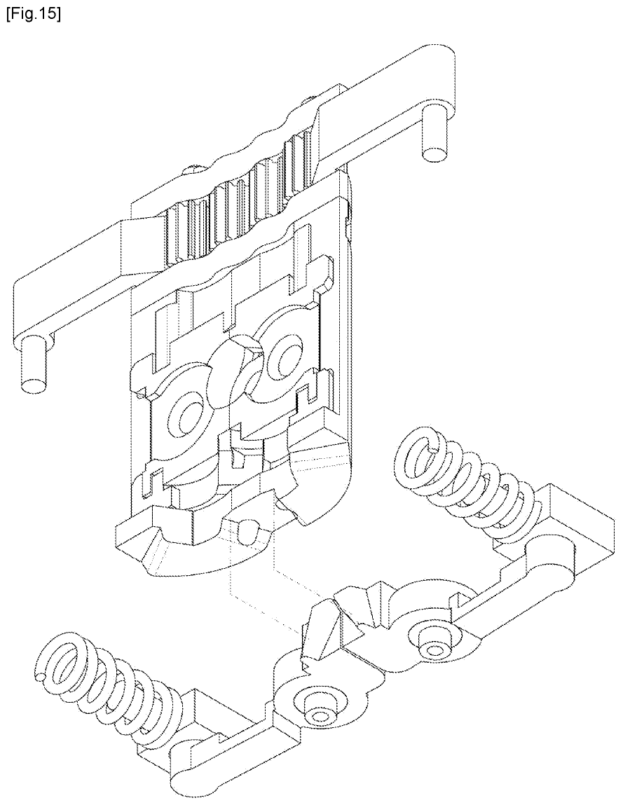

FIG. 13 is a perspective view of a state in which a first end of a rotation rod is installed in an elasticity control portion according to the invention. FIG. 14 is a perspective view illustrating a configuration of the elasticity control portion according to the invention in FIG. 13. FIG. 15 is a perspective view illustrating a configuration of the elasticity control portion according to the invention in FIG. 14 in a state in which a rotation link, a connection gear, and an aim gear have been assembled into a rotation unit body.

Referring to FIGS. 13 to 15, the second ends 132 which are formed to be convex are formed in the rotation rods 32 connected to the connecting plates 30 to rotate.

The elasticity control portion 50 is formed on one end surface of the rotation unit body 73. The elasticity control portion 50 includes the first recessed portion 82 that is formed to be concave at the center thereof, the protruding portions 84 that are formed to be convex on both sides of the first recessed portion 82, and the second recessed portion 86 that is formed outside of the convex portions 84.

When the connecting plates 30 to which the rotation rods 32 are connected are folded or unfolded, the rotation rods 32 rotate. When the rotation rods 32 rotate, the second ends 132 of the rotation rods 32 move along the first recessed portion 82 that is formed to be concave at the center of the elasticity control portion 50, the protruding portions 84 that are formed to be convex on both sides of the first recessed portion 82, and the second recessed portion 86 that is formed outside of the convex portions 84.

When the second ends 132 of the rotation rods 32 are located in the first recessed portion 82 and the second recessed portion 86, the springs 36 are not compressed or extended. When the second ends 132 are located in the protruding portions 84, the springs 36 are compressed to generate an elastic force.

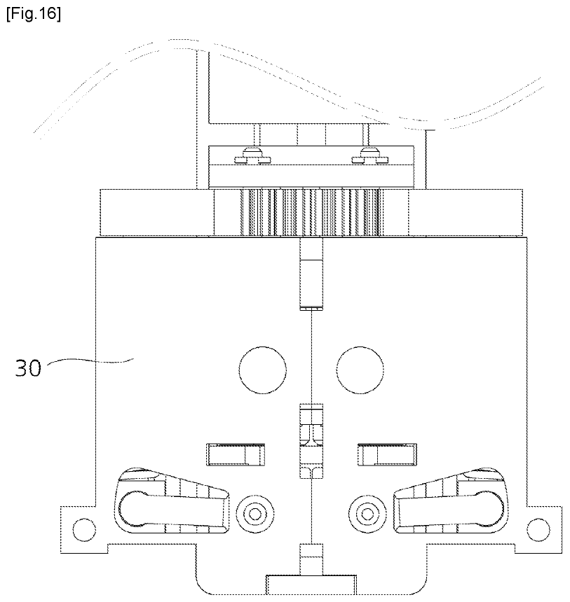

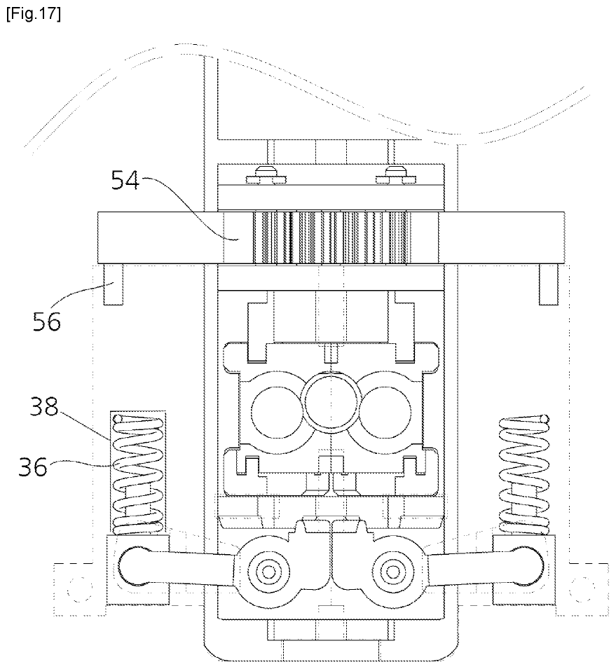

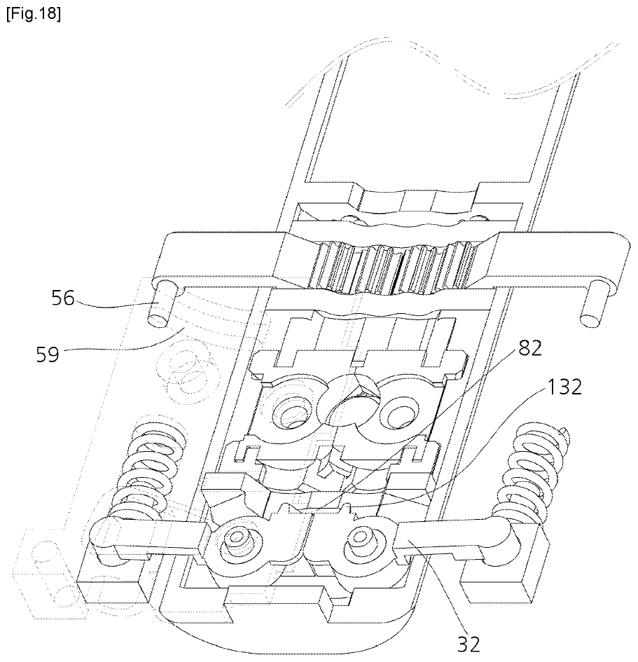

FIG. 16 is a plan view illustrating a state in which the connecting plates has been unfolded in the hinge structure for an in-folding type display device according to the invention. FIG. 17 is a plan view illustrating an internal structure of a pair of connecting plates in a state in which the connecting plates have been unfolded in the hinge structure for an in-folding type display device according to the invention. FIG. 18 is a perspective view illustrating an internal structure of a pair of connecting plates in a state in which the connecting plates have been unfolded in the hinge structure for an in-folding type display device according to the invention.

Referring to FIGS. 16 to 18, in a state in which the pair of upper panels 10 of the hinge structure for an in-folding type display device according to the invention has been unfolded, the connection plates 30 connected to the upper panels 10 are also in an unfolded state.

When the connecting plates 30 are unfolded, the second ends 132 protruding from the rotation rods 32 are located in the first recessed portion 82 of the elasticity control portion 50.

In the state in which the upper panels 10 have been unfolded, the rotation rods 32 do not rotate on the connecting plates 30, and thus the springs 36 accommodated in the accommodation portions 38 do not have an external force applied thereon and are not compressed.

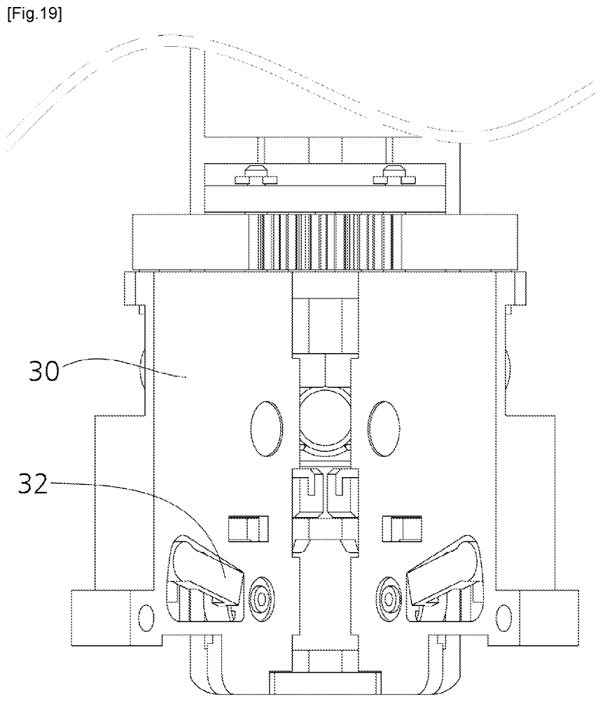

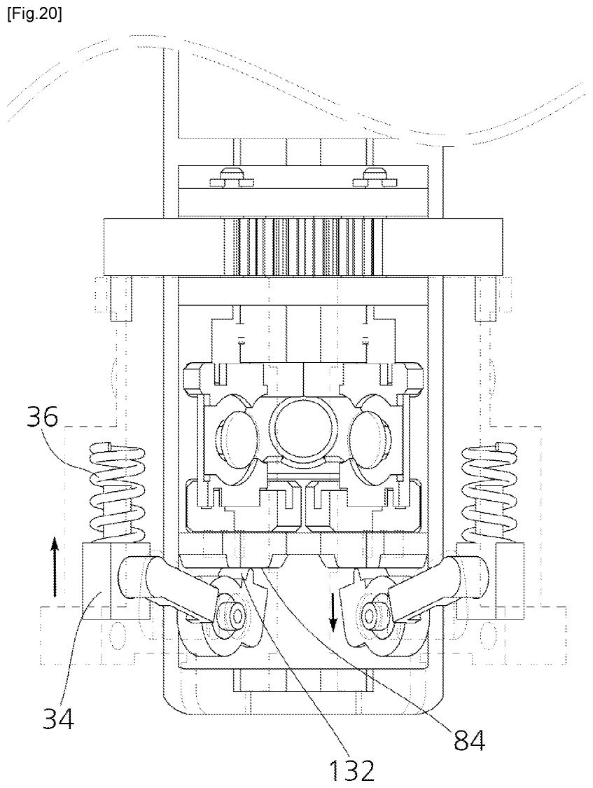

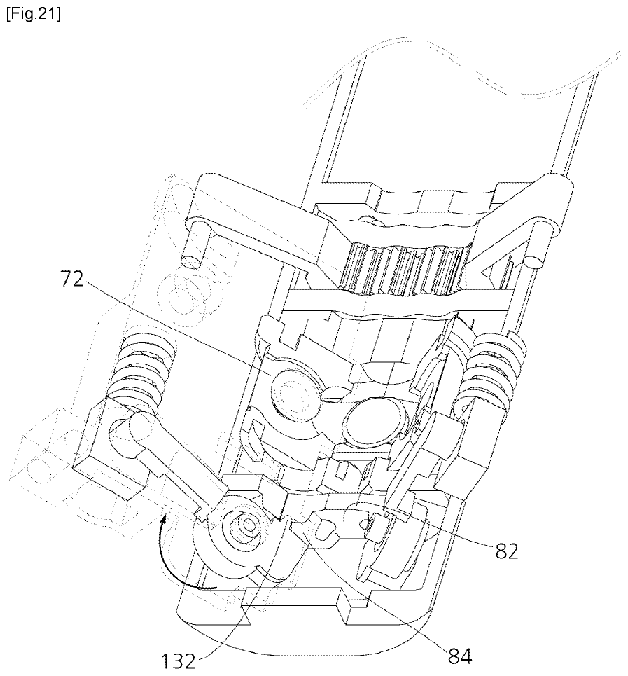

FIG. 19 is a plan view illustrating a state in which the connecting plates are being folded in the hinge structure for an in-folding type display device according to the invention. FIG. 20 is a plan view illustrating an internal structure of a pair of connecting plates in a state in which the connecting plates are being folded in the hinge structure for an in-folding type display device according to the invention. FIG. 21 is a perspective view illustrating an internal structure of a pair of connecting plates in a state in which the connecting plates are being folded in the hinge structure for an in-folding type display device according to the invention.

Referring to FIGS. 19 to 21, when a user folds the upper panels 10, the second ends 132 of the rotation rods 32 connected to the connecting plates 30 move from the recessed portion 82 to the protruding portion 84 of a convex shape and are located therein.

When the second ends 132 move over the protruding portions 84, the rotation rod 32 rotates to a side opposite to the side on which the second ends 32 are located, and the rods 34 connected to the first ends 131 compress the springs 36 disposed in the accommodation portions 38.

In this case, the connecting plates 30 can be maintained in an intermediately folded state unless an external force is not applied thereto by a user or the like.

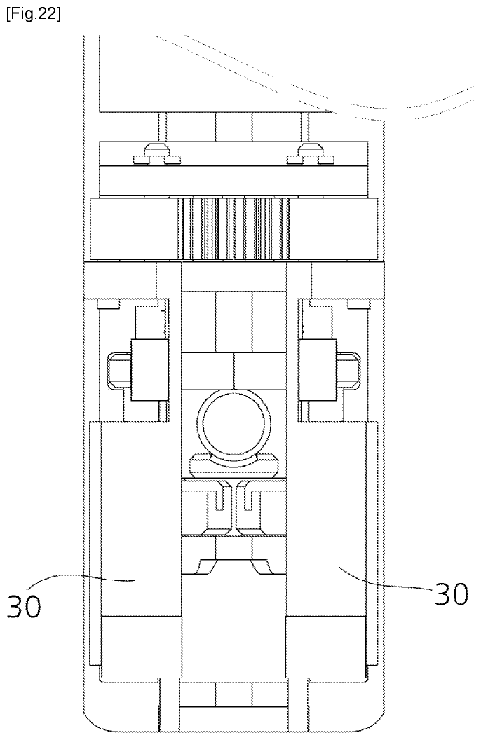

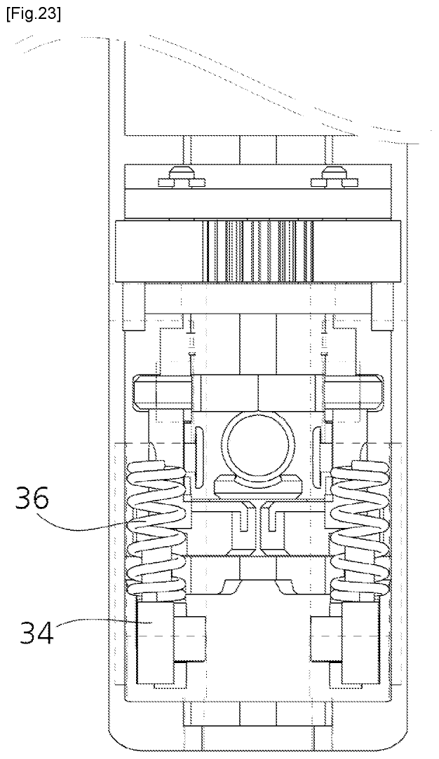

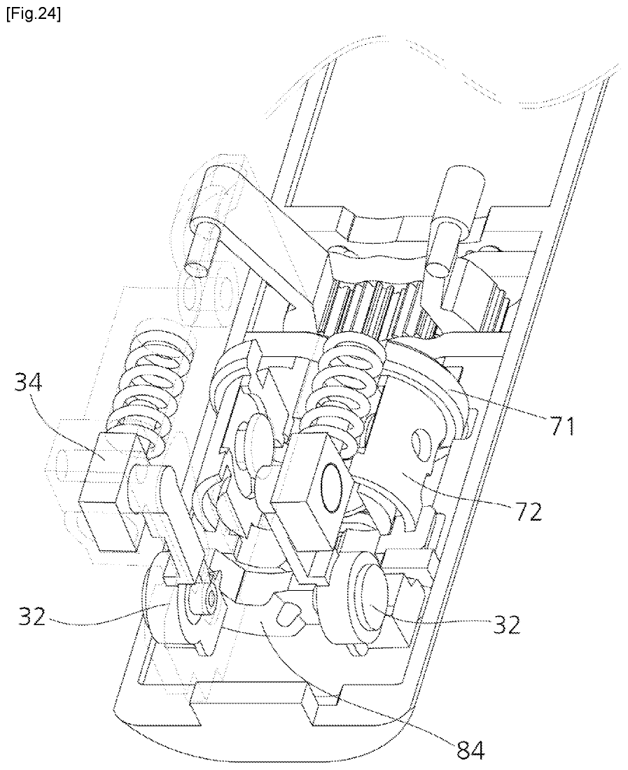

FIG. 22 is a plan view illustrating a state in which the connecting plates have been fully folded in the hinge structure for an in-folding type display device according to the invention. FIG. 23 is a plan view illustrating an internal structure of a pair of connecting plates in a state in which the connecting plates have been fully folded in the hinge structure for an in-folding type display device according to the invention. FIG. 24 is a perspective view illustrating an internal structure of a pair of connecting plates in a state in which the connecting plates have been fully folded in the hinge structure for an in-folding type display device according to the invention.

Referring to FIGS. 22 to 24, when the user further folds the upper panels 10 than illustrated in FIG. 21, the second ends 132 of the rotation rods 32 connected to the connecting plates 30 move down from the protruding portion 84 to the second recessed portion 86 which is concave and are located therein.

When the second ends 132 of the rotation rods 32 move down to the second recessed portion 86 which is concave, the rotation rods 32 rotate to the side on which the second ends 132 are located, and the compressed springs 36 disposed in the accommodation portions 38 are restored to the original state in which no external force is applied.

When the second ends 132 of the rotation rods 32 connected to the connecting plates 30 move from the protruding portion 84 to the second recessed portion 86, the connecting plates 30 is fully folded in a semi-automatic manner.

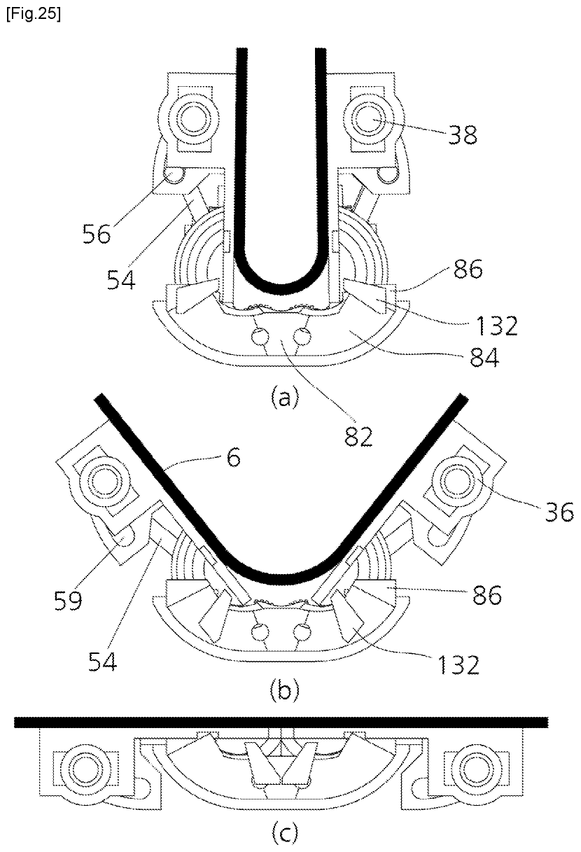

FIG. 25 is a cross-sectional front view illustrating a state in which a second end of a rotation rod is moving on the elasticity control portion with movement of the pair of connecting plates in the hinge structure for an in-folding type display device according to the invention.

Referring to FIG. 25, when the connecting plates 30 are unfolded, the second ends 132 protruding from the rotation rods 32 are located in the first recessed portion 82 of the elasticity control portion 50.

When a user folds the upper panels 10, the second ends 132 of the rotation rods 32 connected to the connecting plates 30 moves over from the recessed portion 82 to the protruding portion 84 which are convex and are located therein.

When the second ends 132 moves over to the protruding portion 84 which are convex, the rotation rods 32 rotate to a side opposite to the side on which the second ends 132 are located, and he rods 34 connected to the first ends 131 compress the springs 36 disposed in the accommodation portions 38.

When the user further folds the connecting plates 30, the second ends 132 of the rotation rods 32 connected to the connecting plates 30 move down from the protruding portion 84 to the second recessed portion 86 which is concave and are located therein.

When the second ends 132 of the rotation rods 32 move down to the recessed portion 86 which is concave, the compressed springs 36 disposed in the accommodation portions 38 are restored to the original state in which no external force is applied.

When the second ends 132 of the rotation rods 32 connected to the connecting plates 30 move from the protruding portion 84 to the second recessed portion 86, the connecting plates 30 is fully folded in a semi-automatic manner.

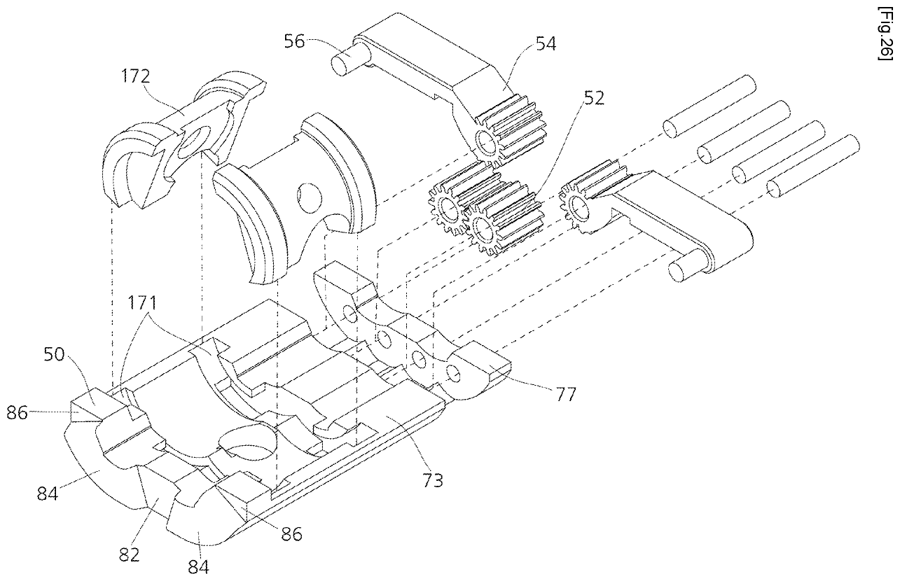

FIG. 26 is an exploded perspective view illustrating another example of the rotation unit module illustrated in FIG. 10.

Referring to FIG. 26, another example of the rotation unit module 70 illustrated in FIG. 10 includes a pair of first rotation links 172 that are connected to the connecting plates 30 and rotate therewith and a rotation unit body 73 that has an arc-shaped rail groove 171 formed therein such that the first rotation links 172 are inserted thereinto and rotate together.

The first rotation links 172 are configured to rotate along the rail grooves 171 formed in an arc shape in the rotation unit body 73.

The rotation unit module according to this example has a configuration in which the first rotation links 172 are directly connected to the rotation unit body 173 without using the rail 71 illustrated in FIG. 10 and rotate along the rail grooves 171.

While an exemplary embodiment of the invention has been described above using specific terms, such description is only for explanation and it is obvious that the embodiment can be modified in various forms without departing from the technical spirit and scope of the appended claims. Such modified embodiments should not be understood separately from the spirit and scope of the invention and should belong to the appended claims.

1. A hinge structure for an in-folding type display device, the hinge structure comprising:
a pair of connecting plates that rotates in opposite directions;
an elasticity unit that provides an elastic force to rotation of the connecting plates;
a plate connecting portion that connects the pair of connecting plates; and
an elastic connecting portion that connects the connecting plates and the elasticity unit by causing the elasticity unit to generate an elastic force when the pair of connecting plates rotate.

2. The hinge structure for an in-folding type display device according to claim 1, wherein an elasticity control portion that includes a first recessed portion, a protruding portion, and a second recessed portion to correspond to an angle by which the connecting plates are folded is provided in the elastic connecting portion,
wherein the elasticity unit does not generate an elastic force when the elastic connecting portion is located in the first and second recessed portions, and
wherein the elasticity unit generates an elastic force when the elastic connecting portion is located in the protruding portion.

3. The hinge structure for an in-folding type display device according to claim 1, wherein a rotation link that supports rotation of the connecting plates is provided in the plate connecting portion.

4. The hinge structure for an in-folding type display device according to claim 3, wherein the rotation link rotates along a rail, and
wherein the rail rotates about a portion connected to the connecting plates.

5. The hinge structure for an in-folding type display device according to claim 2, wherein the connecting plates are unfolded straightly when the elastic connecting portion is located in the first recessed portion.

6. The hinge structure for an in-folding type display device according to claim 2, wherein the connecting plates are folded straightly when the elastic connecting portion is located in the second recessed portion.
